(19) United States
(12) Patent Application Publication
(10) Pub. No.: US 2026/0365522 A1
(43) Pub. Date: Nov. 19, 2026

(54) Composite Phase Diamond Material, A Method of Fabricating the Material and Use of the Material

(71) Applicant: City University of Hong Kong, Kowloon (HK)

(72) Inventors: Jian LU, Kolwoon (HK); Jianan YIN, Kolwoon (HK)

(21) Appl. No.: 18/756,167

(22) Filed: Jun. 27, 2024

Related U.S. Application Data
(60) Provisional application No. 63/516,956, filed on Aug. 1, 2023.

(51) Int. Cl. C01B 32/26; G01K 7/22

(52) U.S. Cl. CPC C01B 32/26; G01K 7/226; C01P 2002/02; C01P 2002/72; C01P 2004/04; C01P 2006/40; G01K 2203/00

(57) ABSTRACT

A composite phase diamond material includes a sp³-hybridized region and one or more sp2-hybridized regions where the sp²-hybridized regions are located in the sp³-hybridized region. A method of fabricating the composite phase diamond material includes the steps of: providing a precursor including a carbon raw material, providing a polymer formation composition, and heating the precursor to form the composite phase diamond material. The polymer formation composition contains a polymerizable binder. The present invention further provides a method for temperature sensing, including cryogenic temperature sensing, using a sensor including the composite phase diamond.

### FIELD OF THE INVENTION

The present invention relates to a composite phase diamond material. The present invention also relates to a method of fabricating the composite phase diamond material. The present invention further relates to use of the composite phase diamond material.

### BACKGROUND

Diamond is a naturally occurring material renowned for its unique properties such as exceptional hardness and thermal conductivity, wide band gap and high stability, which render it an ideal material for various uses, especially in extreme environments. However, due to the absence of free electrons, diamond exhibits low electrical conductivity. It is challenging to modify properties of diamond by conventional industrial processes, which severely limits industrial application of diamond.

In recent years, some researchers have attempted to increase the electrical conductivity of diamonds by existing methods such as doping, making them suitable for practical applications. Although conductive diamond has extended to promising applications in fields such as chemical and biochemical sensing, environmental degradation, electrosynthesis, electrocatalysis, quantum mechanics, superconductors, medical, space equipment and energy storage and conversion, its practical use is restricted by difficult and cumbersome mechanical processing and high production costs. Furthermore, due to its crystalline lattice, the process of making diamond conductive often compromises its mechanical properties and thermal stability.

Temperature is one of the seven fundamental physical quantities. Low-temperature physics is a critical field that can help improve our understanding of the universe, matter, and technology. At temperatures close to absolute zero, matter exhibits a range of unusual and exotic properties that cannot be observed at higher temperatures; these properties are important in several related fields such as quantum computing, quantum simulation, superfluidity, and Bose-Einstein condensation. The ability to measure temperatures approaching absolute zero has driven numerous advances in low-temperature physics and quantum physics. Currently, millikelvin temperatures and below are measured through the characterization of a certain thermal state of the system as there is no traditional thermometer capable of measuring temperatures at such low levels. Although quantum gases with a temperature of 38 pK have already been produced in the laboratory, traditional thermometers can only measure temperatures higher than 20 mK. Lowering the temperature measurement limit is important, particularly for practical applications of various technologies in the fields of low-temperature physics and quantum physics.

A few sp2-hybridized carbon materials have shown good potential for cryogenic temperature measurements. Compared to diamond, graphite has a softer texture and inferior mechanical properties, making it highly susceptible to flaking or getting damaged during use. The extraordinarily low coefficient of thermal expansion, exceptional hardness, wide band gap, and high hole mobility of diamond render it an ideal material for temperature measurement in extreme environments.

Therefore, there remains a need for an improved carbon material that is applicable for cryogenic temperature measurements without drawbacks of existing materials. There is also a need for a low-cost method to produce such conductive diamond without sacrificing a diamond's inherent desirable properties.

### SUMMARY OF THE INVENTION

An aspect of the present invention proposes a carbon material (i.e. diamond material) with sp²-sp³ composite phase to tackle the abovementioned problems, in particular, to overcome the bottleneck of low-temperature measurement. Furthermore, the combination of sp2-hybridized phase with diamond can significantly impact the electrical conductivity, bandgap, and other characteristics of diamond-based materials. This approach provides insights into the potential applications of diamond in the field of electronics. The diamond material may be called a composite phase diamond (CPD)

Another aspect of the present invention proposes a method for fabricating the CPD via a straightforward and cost-efficient approach involving heat-treatment on precursors under atmospheric pressure conditions. This process can prepare CPD with a negative temperature coefficient and a highly fitted resistance-temperature (R-T) curve. The lowest temperature measurement limit of the CPD is 1 mK.

Furthermore, the CPD has demonstrated remarkably low sensitivity to magnetic fields and excellent thermal stability, which significantly expands its potential applications as a material for temperature measurement, especially cryogenic temperature measurement. This composite phase structural design has been successfully implemented across various scales. For example, a micrometer-scale CPD probe and a centimeter-scale 3D printing CPD were developed. The CPD is a promising material for the manufacture of next-generation cryogenic temperature sensors and opens up new potential for functional diamond applications.

One aspect of this invention relates to a composite phase diamond material including a sp³-hybridized region and one or more sp²-hybridized regions. The sp²-hybridized regions are located in the sp³-hybridized region.

In an embodiment, the sp²-hybridized regions are spaced from each other in form of one or more clusters distributed in the sp³-hybridized region.

In an embodiment, the composite phase diamond includes one or more amorphous carbon regions.

In an embodiment, at least one of the amorphous carbon regions adjoins at least respective one of the sp2-hybridized regions to form a cluster.

In an embodiment, the cluster is spaced from another cluster.

In an embodiment, the composite phase diamond comprises irregularities at the interface between the sp³-hybridized region and the sp²-hybridized regions

In an embodiment, the composite phase diamond material is electrically conductive.

In an embodiment, the composite phase diamond material is insensitive to magnetic field; in particular, the composite phase diamond material is insensitive to magnetic field at a temperature from about −263 °C to about 200 °C.

In an embodiment, the composite phase diamond material comprises:
from about 50 vol. % to about vol. 90% of the sp³-hybridized region and from about 10 vol. % to about 50% of the sp²-hybridized regions, based on the total volume of the composite phase diamond material; or
from about 50 vol. % to about vol. 70% of the sp³-hybridized region and from about 30 vol. % to about 50% of the sp²-hybridized regions, based on the total volume of the composite phase diamond material; or
from about 50 vol. % to about vol. 60% of the sp³-hybridized region and from about 40 vol. % to about 50% of the sp²-hybridized regions, based on the total volume of the composite phase diamond material.

In an embodiment, the composite phase diamond material comprises:
from about 50 vol. % to about vol. 90% of the sp³-hybridized region, from about 10 vol. % to about 50% of the sp²-hybridized regions and from about 10 vol. % to about 50% of the amorphous carbon regions, based on the total volume of the composite phase diamond material; or
from about 50 vol. % to about vol. 60% of the sp³-hybridized region, from about 20 vol. % to about 40% of the sp²-hybridized regions and from about 10 vol. % to about 30% of the amorphous carbon regions, based on the total volume of the composite phase diamond material.

Another aspect of this invention relates to a method for fabricating the composite phase diamond material including the steps of: a) providing a precursor including a carbon raw material, b) providing a polymer formation composition; and c) heating the precursor and the polymer formation composition to form the composite phase diamond material. The polymer formation composition contains a polymerizable binder.

In an embodiment, the method comprises a polymerization step wherein the polymerizable binder at least partially polymerizes, prior to the heating step c).

In an embodiment, the method comprises a mixing step for mixing the polymer formation composition with the precursor prior to the polymerization step, i.e. before the polymerizable binder polymerizes.

In an embodiment, the carbon raw material comprises an original diamond; optionally, wherein the carbon raw material further comprises an amorphous carbon and/or a graphite.

In an embodiment, the carbon raw material comprises a material selected from the group consisting of an original diamond, an amorphous carbon, a graphite, and a combination thereof.

In an embodiment, the heating step c) comprises a step of transforming part of the original diamond to graphite fragments, or wherein from about 10 vol. % to about 50% of the original diamond are transformed to the graphite fragments.

In an embodiment, the step of transforming part of the original diamond to graphite fragments comprises a step of transforming part of the original diamond to amorphous carbon.

In an embodiment, the polymer formation composition comprises an initiator.

In an embodiment, the carbon raw material is in a form selected from the group consisting of a powder, a film, a bulk, and a combination thereof.

In an embodiment, the composite phase diamond material is in a form selected from the group consisting of a powder, a film, a bulk, and a combination thereof.

In an embodiment, the binder comprises an organic binder; or wherein the binder comprises an organic material selected from the group consisting of ammonium polyacrylate, methyl methacrylate, acrylamide, di(propylene glycol) diphenylate, N-hydroxyethyl acrylamide and styrene, and a combination thereof.

In an embodiment, the initiator comprises a photosensitive initiator; or wherein the initiator is selected from the group consisting of N,N′-Methylenebisacrylamide, 2-hydroxy-2-methylpropiophenone, triphenylborane, 1-pyrroline-5-carboxylic acid, 2-hydroxy-2-methyl-1-phenyl-1-propanone, phenyl bis(2,4,6-trimethyl benzoyl), diphenyl(2,4,6-trimethylbenzoyl)phosphine oxide and a combination thereof.

In an embodiment, the initiator comprises two different photosensitive initiators.

In an embodiment, the polymer formation composition further comprises a thickener; or, wherein the thickener comprises a polymer; or wherein the thickener is water soluble; or wherein the thickener is silicon free; or wherein the thickener is metal ion free.

In an embodiment, the thickener is selected from the group consisting of polyacrylamide, sodium carboxymethyl cellulose, poly(acrylate ammonium), and polyvinyl alcohol, and a combination thereof.

In an embodiment, the binder is a water soluble binder and/or an oil soluble binder.

In an embodiment, the initiator comprises a photosensitive initiator, or wherein the initiator absorbs light with a wavelength from about 245 nm to about 400 nm.

In an embodiment, the heating step further comprises a sintering step.

In an embodiment, the heating step takes place at a temperature from about 900 °C to about 2200 °C, or from about 900 °C to about 1600 °C.

In an embodiment, the heating step takes place in an atmosphere comprising a gas selected from the group consisting of argon, nitrogen, and a combination thereof.

In an embodiment, the heating step takes place under a pressure of about 1 atm.

In an embodiment, the heating step comprises a holding time of from about 1 hour to about 300 hours, or from about 1 hour to about 80 hours, or from about 5 hours to about 80 hours.

In an embodiment, the method comprises a treatment step comprising a treatment selected from the group consisting of focused ion beam treatment, 3D printing, plasma assisted polishing, and a combination thereof.

A further aspect of this invention relates to use of a composite phase diamond material according to the embodiments of the present invention or a composite phase diamond material fabricated by the method according to the embodiments of the present invention on temperature sensing including cryogenic temperature sensing.

A further aspect of this invention relates to a method for temperature sensing, including cryogenic temperature sensing, comprising the steps of: a) providing a sensor comprising a composite phase diamond material according to the embodiments of the present invention or a composite phase diamond fabricated by the method according to the embodiments of the present invention, b) placing the sensor at a location where the temperature is to be measured, and c) obtaining a signal corresponding to the temperature of the location from the sensor.

Without intending to be limited by theory, it is believed that the present invention may provide a new type of composite phase diamond material (or composite phase diamond) with both a sp³-hybridized phase and a sp²-hybridized phase. The composite phase diamond material herein may exhibit one or more properties such as, but not limited to, high hardness, high electrical conductivity, high thermal stability, a negative temperature coefficient, linear magnetoresistance, etc. The composite phase diamond material has potential applications in various fields including, for example, temperature sensors, infrared sensors, precision electron probes, high-temperature electronic devices, magnetic topological devices, etc. It is believed that the process for preparing the composite phase diamond material is straightforward, and can be applied to a wide range of carbon raw materials forms including, for example, particles, thin films, bulk single crystals, and bulk polycrystals, thereby exhibiting great versatility.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows images taken by high-resolution transmission electron microscopy (HRTEM) with corresponding fast Fourier transform (FFT) and selected-area electron-diffraction (SAED) images showing the nanostructure characteristics of the nano composite phase structure, according to an embodiment of the CPD material of the present invention;

FIG. 2 are graphs showing performance of the temperature sensing characteristics of the CPD according to an embodiment of the present invention;

FIG. 3 are graphs showing performance of the temperature sensing characteristics of the CPD according to an embodiment of the present invention;

FIG. 4 are graphs showing thermal stability of the CPD according to an embodiment of the present invention;

FIG. 5 are graphs showing structural characterization of the CPD according to an embodiment of the present invention;

FIG. 6 shows nano dual-phase structure of an embodiment of the CPD of the present invention;

FIG. 7 is a graph comparison of the conductivity of the CPD according to an embodiment of the present invention with those of other conductive diamonds;

FIG. 8 shows graphs of spectroscopic analysis of energy band information of the CPD according to an embodiment of the present invention;

FIG. 9 shows graphs of performance of the temperature sensing characteristics of the CPD according to an embodiment of the present invention;

FIG. 10 shows graphs of statistical analysis of the resistance discreteness of the CPD according to an embodiment of the present invention;

FIG. 11 shows graphs of the response time of the CPD according to an embodiment of the present invention during rapid temperature changes;

FIG. 12 shows images of samples of the CPD according to an embodiment of the present invention;

FIG. 13 shows resistance-temperature (R-T) curves of samples of the CPD according to an embodiment of the present invention with different sizes;

FIG. 14 shows a graph of stability of the CPD under magnetic fields;

FIG. 15 shows a graph of effect of heat treatment conditions on the thermal stability of the CPD according to an embodiment of the present invention;

FIG. 16 shows graphs of oxidation of original diamond at different temperatures;

FIG. 17 shows graphs of oxidation of the CPD according to an embodiment of the present invention at different temperatures;

FIG. 18 shows graphs of thermal properties of the CPD according to an embodiment of the present invention;

FIG. 19 shows schematic diagram of an embodiment of the CPD of the present invention;

FIG. 20 shows a graph comparing hardness of an original diamond with the CPD prepared by an embodiment of the method of the present invention.

### DESCRIPTION OF THE PREFERRED EMBODIMENTS

Unless otherwise specifically provided, all tests herein are conducted at standard conditions which include a room and testing temperature of 25 °C, sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

The term “precursor” as used herein refers to a material that includes the carbon raw material which reacts to form the composite phase diamond (“CPD”) material.

Composite phase diamond (“CPD”) contains sp2-sp3 composite phase. The CPD may also be referred as dual-phase diamond (“DPD”);

The term “organic-coated precursor” may refer to the precursor mixed with a binder. In particular, the term “organic-coated precursor” may refer to the precursor coated by the polymerized binder

An embodiment of the present invention relates to a CPD material including a sp³-hybridized region and one or more sp²-hybridized regions. In the invention herein, both the sp³-hybridized region and sp²-hybridized regions are carbon regions but with different configurations among the respective carbon atoms. The CPD material herein may exhibit one or more properties such as, but not limited to, high hardness, high electrical conductivity, high thermal stability, a negative temperature coefficient, linear magnetoresistance, etc.

In an embodiment of the present invention, the sp²-hybridized regions are located in the sp³-hybridized region and may in addition, distributed throughout the sp³-hybridized region. It may be regarded that the sp² hybridized regions are introduced to the sp³-hybridized region, thus forming the CPD material. The dual-phase may be regarded as substantially structured as containing the sp³-hybridized phase and sp²-hybridized phase. Without intending to be limited by theory it is believed that this feature of the CPD material may distinguish the CPD material from those diamonds in the prior art that do not have dual phases. Even if there are some diamonds with dual phases from the prior art, they may, for instance, only have a phase placed on a surface of another phase, with a rather clear boundary in between, e.g. with a one-sided boundary line and/or the boundary line being more regular with less curves and turns. In contrast, the CPD material of the present invention has the feature of sp²-hybridized phases forming island-like regions/clusters distributing throughout the sp³-hybridized phase, which may bring about at least the electrically conductive property to the CPD material, particularly throughout the CPD material, while a substantial sp³-structure contributed by the sp³-hybridized phase remains.

In an embodiment of the present invention, the sp²-hybridized regions are in form of one or more clusters and may be spaced from each other. In some cases, the sp²-hybridized regions may be substantially evenly distributed throughout the sp³ hybridized region. In other terms, some regions of the sp²-hybridized phase are inside the sp³-hybridized phase and some regions of the sp²-hybridized phases are exposed at the outer surface of the sp³-hybridized phase (thus the outer surface of the CPD). In some cases, the CPD material includes one or more amorphous carbon regions, where at least one of the amorphous carbon regions adjoins at least respective one of the sp²-hybridized regions to form a cluster. The cluster may be spaced from another cluster.

It can be appreciated that, in general, the CPD has only a sp³-hybridized phase and a sp²-hybridized phase. In the sp³-hybridized phase of the CPD, the CPD has basically one sp³-hybridized region which appears as a continuous region throughout the CPD material. Other terminologies similar or equivalent to sp³-hybridized region may be used in other places of the description according to the context they belong, such as diamond matrix and diamond lattice, and etc. In the sp²-hybridized phase of the CPD, the CPD has multiple sp²-hybridized regions or multiple graphite regions. Other terminologies similar or equivalent to sp²-hybridized regions may be used in other places of the description according to the context they belong, such as graphite, graphite fragments, graphite regions, and etc. The CPD may further contain an amorphous carbon phase, in which the CPD has multiple amorphous carbon regions.

In an embodiment of the present invention, the CPD material is electrically conductive.

In an embodiment of the present invention, the CPD material is insensitive to magnetic field. In particular, the CPD material is insensitive to a magnetic field at a temperature above about −263 °C, or above from about −263 °C to about 200 °C, or from about −200 °C to about 100 °C. Furthermore, it is believed that the CPD material exhibits the characteristics of linear magnetoresistance below about −263 °C temperature. Without intending to be limited by theory, it is believed that this allows the CPD material to be used in a magnetic field.

This CPD material according to the embodiments of the present invention may be conductive and insensitive to magnetic fields. With an increased initial oxidation temperature of over 200 °C and retained hardness, the present invention is believed to be an ideal semiconductor material for extreme environments and quantum devices. Compared to traditional methods of high-temperature, high-pressure processes, the method in the embodiments of the present invention is simpler, cost-effective, and suitable for industrial production. It is believed that the organic coated diamond precursor system can be applied to various forms of carbon raw materials for forming CPD materials.

In an embodiment of the present invention, the CPD material comprises from about 50 vol. % to about vol. 90% of the sp³-hybridized region and from about 10 vol. % to about 50% of the sp²-hybridized regions, based on the total volume of the composite phase diamond material. Optionally, the CPD material comprises from about 50 vol. % to about vol. 70% of the sp³-hybridized region and from about 30 vol. % to about 50% of the sp²-hybridized regions. Optionally, the CPD material comprises from about 50 vol. % to about vol. 60% of the sp³-hybridized region and from about 40 vol. % to about 50% of the sp²-hybridized regions. Optionally, CPD material comprises about 50 vol. % of the sp³-hybridized region and about 50 vol. % of the sp²-hybridized regions.

In an embodiment of the present invention, the CPD material comprises from about 50 vol. % to about vol. 90% of the sp³-hybridized region, from about 10 vol. % to about 50% of the sp²-hybridized regions and from about 10 vol. % to about 50% of the amorphous carbon regions. Optionally, the CPD material comprises from about 50 vol. % to about vol. 60% of the sp³-hybridized region, from about 20 vol. % to about 40% of the sp²-hybridized regions and from about 10 vol. % to about 30% of the amorphous carbon regions.

In the embodiments, “vol. %” means volume fraction (%) of the sp³-hybridized region, the sp²-hybridized regions or the amorphous carbon regions.

In an embodiment of the present invention, the CPD material comprises from about 50 vol. % to about vol. 70% of the sp³-hybridized region and from about 30 vol. % to about 50% of the sp²-hybridized regions. Optionally, the CPD material comprises from about 60 vol. % to about vol. 70% of the sp³-hybridized region and from about 30 vol. % to about 40% of the sp²-hybridized regions.

In an embodiment of the present invention, the CPD material comprises from about 60 vol. % to about vol. 70% of the sp³-hybridized region, from about 30 vol. % to about 40% of the sp²-hybridized regions and from about 0 vol. % to about 10% of the amorphous carbon regions.

Another embodiment of the present invention relates to a method of fabricating a CPD material, including the steps of: providing a precursor including a carbon raw material; providing a polymer formation composition including a polymerizable binder; and heating the precursor and the polymer formation composition to form the CPD material.

Without intending to be limited by theory, it is believed that this method is easy to set up and cost-effective. The method herein may dispense with high-pressure and high temperature processes compared with other conventional methods.

In an embodiment of the present invention, the carbon raw material includes an original diamond. The original diamond may refer to a diamond with substantially only, or only, a sp³ phase. The original diamond may be in form of a powder or a bulk single crystal diamond. Optionally, the carbon raw material further includes an amorphous carbon and/or a graphite, in addition to the original diamond. Without intending to be limited by theory, it is speculated that including more than one form of carbon materials in the carbon raw materials, in particular including original diamond along with one or more other forms of carbon materials, may potentially accelerate the formation of the CPD material or enhance the CPD's quality and performance.

In an embodiment of the present invention, the carbon raw material includes a material selected from the group of an original diamond, an amorphous carbon, a graphite, and a combination thereof.

In an embodiment of the present invention, the method includes a polymerization step where the polymerizable binder at least partially polymerizes, prior to the heating step. The polymerizable binder undergoes the polymerization step before heating. The polymerization step usually takes place in an oven with temperature from about 60 to about 150 °C, or under irradiation by UV light with a wavelength from about 245 to about 400 nm. The above conditions to be applied for the polymerization step may depend on the type of binder to be used. The polymerization step may be an important process for the formation the CPD material. A higher polymerization degree may lead to better results, such as higher conductivity. However, it is not necessary for the polymerization degree to be 100% in order to obtain an acceptable result for the formation the CPD material. For instance, the polymerization degree may be from about 1% to about 100%, or from about 20% to about 100%, or from 30% to about 100%, or from about 40% to about to about 100%, or from about 50% to about to about 100%, or from about 60% to about to about 100%, or from about 70% to about to about 100%, or from about 80% to about 100%, or from about 90% to about 100%.

In an embodiment of the present invention, the polymer formation composition is mixed with the precursor prior the polymerization step or before the polymerizable binder polymerizes. This may allow the precursor to be coated by the polymerized binder.

In an embodiment of the present invention, the polymer formation composition includes an initiator. The initiator may initiate or speed up the polymerization step of the binder, depending on which binder is used.

It is believed that the carbon raw material is the major source of carbon forming the CPD material. However, it is not intended to completely rule out the possibility that there may be other sources of carbon forming the CPD material other than the carbon raw material, such as the carbons from the initiator, although the chance is relatively small.

In an embodiment of the present invention, the carbon raw material is in a form selected from the group of a powder, a film, a bulk, and a combination thereof. Different forms of carbon raw materials may be used depending on target forms of the CPD material and/or what binders and/or initiators to be used. For instance, carbon raw material powder may be used to form 3D printed CPD material. A bulk carbon raw material may be used to form a bulk CPD material.

In an embodiment of the present invention, the CPD material is in a form selected from the group of a powder, a film, a bulk, and a combination thereof. Different forms of CPD material have different uses. For example, a CPD material in a bulk form can be used as a sensing material, a protective cover, an electrode and so on; the CPD material in powder form can be used as conductive powders or fabricated into a conductive probe; the CPD material in film form can be used as display material.

In an embodiment of the present invention, the binder includes an organic binder, or where the binder includes an organic material selected from the group of methyl methacrylate, acrylamide, di(propylene glycol) diphenylate, N-hydroxyethyl acrylamide and styrene, and a combination thereof. The above binders may be used for forming the CPD material. It is noted that using acrylamides shows best results compared with the other binders, since the as-prepared CPD material has the highest conductivity.

In an embodiment of the present invention, the initiator includes a photosensitive initiator, or where, the initiator is selected from the group of triphenylborane, 1-pyrroline-5-carboxylic acid, 2-hydroxy-2-methyl-1-phenyl-1-propanone, phenyl bis(2,4,6-trimethyl benzoyl), diphenyl(2,4,6-trimethylbenzoyl)phosphine oxide and a combination thereof.

In an embodiment of the present invention, the polymer formation composition further includes a thickener. The thickener may include a polymer. The thickener may be water soluble. The thickener may be silicon free. The thickener may be metal ion free.

In an embodiment of the present invention, the thickener is selected from the group of polyacrylamide, sodium carboxymethyl cellulose, poly(acrylate ammonium), and polyvinyl alcohol, and a combination thereof.

In an embodiment of the present invention, the polymer formation composition includes a cross-linking agent for cross-linking the binder. Optionally, the cross-linking agent includes N,N′-Methylenebisacrylamide.

In an embodiment of the present invention, the binder is a water soluble binder and/or an oil soluble binder. The soluble binders facilitates their uniform dispersion.

In an embodiment of the present invention, the initiator includes a photosensitive initiator, or where the initiator absorbs light with a wavelength from about 245 nm to about 400 nm.

In an embodiment of the present invention, the heating step includes a sintering step.

In an embodiment of the present invention, the heating step takes place at a temperature from about 900 °C to about 2200 °C. The heating step taking place in this temperature range is beneficial to form the CPD material. It is believed that the CPD material may not form at a temperature below 900 °C. A temperature higher than 900 °C is preferred. For instance, 2200 °C is a preferred temperature.

In an embodiment of the present invention, the heating step takes place in an atmosphere including a gas selected from the group of argon, nitrogen (N₂) and a combination thereof. The gas can be used as a protective atmosphere to avoid unwanted reactions, such as avoiding oxidation of the CPD material.

In an embodiment of the present invention, the sintering step may further include other sintering processes such as vacuum sintering, hot isostatic pressing sintering, and spark plasma sintering, apart from the aforementioned sintering processes or conditions.

In an embodiment of the present invention, the heating step takes place under a pressure of about 1 atm. It makes the fabricating processes easier to set up as it does not require high-pressure conditions. Without intending to be limited by theory, it is believed that the method herein providing processing under normal pressure is far more economical and easy, although a corresponding method employing high pressure may also be used.

In an embodiment of the present invention, the heating step includes a heating rate from about 1 °C·min⁻¹ to about 100 °C·min⁻¹.

In an embodiment of the present invention, the heating step includes a holding time of from about 1 hour to about 300 hours, or from about 1 hour to about 80 hours, or from about 5 hours to about 80 hours. Longer holding times may bring about the better performance of the CPD material, not only higher thermal stability, but also higher conductivity. Larger samples require longer holding time. For example, a bulk diamond with a size of 5 mm×5 mm×1 mm may need a holding time of 60 hours to achieve an electrical conductivity of about 0.5 Scm⁻¹.

In an embodiment of the present invention, the method of fabricating a CPD material includes a treatment step including a treatment selected from the group of focused ion beam (FIB) treatment, 3D printing, plasma assisted polishing, and a combination thereof. The treatment step may take place after the heating step where the CPD material is formed to treat the as-formed CPD material. The treatment step may take place before the heating step to treat the carbon raw material. It is possible to control or to modify the dimensions of the CPD material, depending on its applications or subsequent treatment step. For instance, the CPD material may be in powder form with suitable particle sizes for 3D printing. It is preferable to control or modify the CPD material into suitable sizes for following FIB treatment. Those skilled in the art would appreciate to use the above sizes or other suitable sizes of CPD material for respective treatment step.

In an embodiment of the present invention, the treatment step includes a 3D printing step before the heating step. Before the treatment step, the polymer formation composition and the precursor are mixed. The mixture of polymer formation composition and precursor is preliminary cured by exposure to a light source, in particular to a UV light source. After the preliminary curing process, the mixture is sintered in the heating step.

The method herein may also include additional processes after the formation of the CPD material. For instance, the as-prepared CPD material may be treated with FIB technique FIB is used as a fabrication technique herein for forming CPD material. FIB may be a milling or sculpting technique to cut diamonds. The cutting may be performed by FIB using “side milling” procedure or “lifting off” procedure. In this way, FIB may act as a subtractive method to reduce the size of or to trim the CPD material, while 3D printing may act as an additive method to increase the side of or to build up the CPD material. For instance, the as-prepared CPD material may be used as semi-product to be further processed by e.g. 3D printing to form a target CPD with a desired shape and size. This enables various products ranging from microns to centimeters, which expands the scope of possible applications. For instance, the as-prepared diamond has potential applications in sensors, microelectromechanical systems supercapacitors, solar cells, quantum devices and electrocatalysis. Furthermore, the CPD material can also be used as electronic devices in extreme environments and high-power electronic devices. The CPD material is conductive, magnetic field insensitive and thermally stable.

### Results

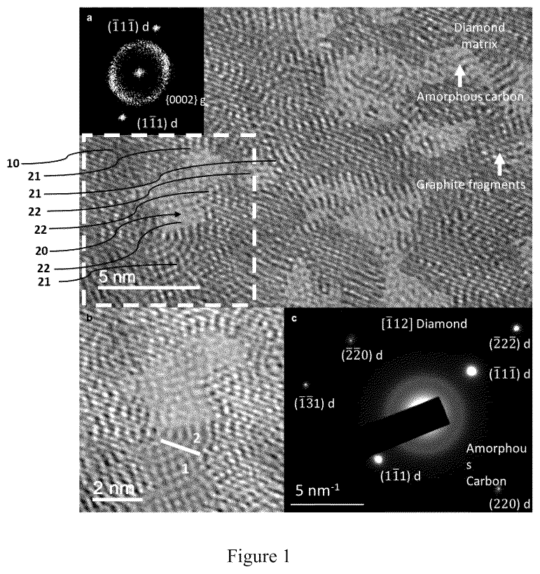

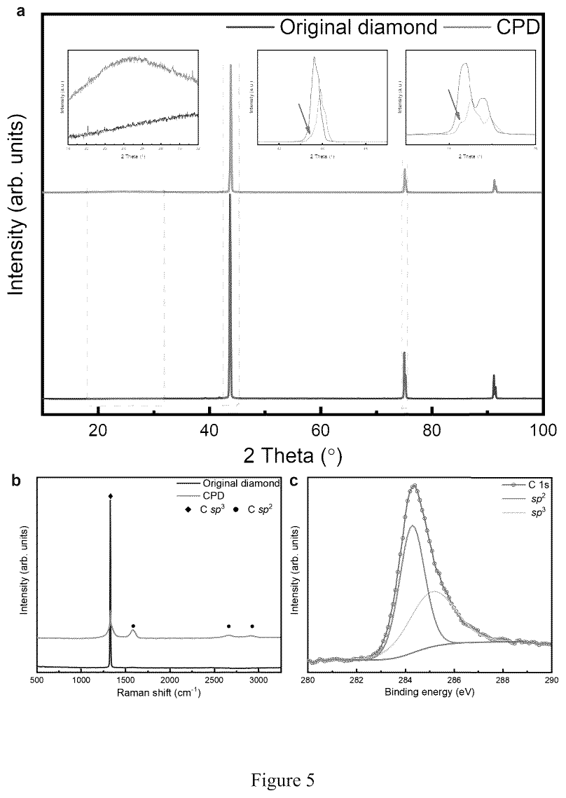

It may be regarded that the CPD is derived as a result of diamond graphitization. Diamond graphitization is generally considered undesirable in the prior art, as it impairs the mechanical properties and thermal stability of the diamond. However, the CPD according to embodiments of the present invention possesses a different structure from those traditional graphitized diamonds in the prior art. The CPD or the methods fabricating the CPD transform the known adversities of graphitization into advantages on the CPD. In particular, those traditional graphitized diamonds generally exhibit distinct boundaries which may deteriorate mechanical properties and thermal stability, owing to significant differences in material properties between the neighboring regions. In contrast, The CPD of the present invention exhibits a different structure where graphite fragments are embedded in the diamond matrix. In particular, the graphite fragments are relatively homogeneously embedded in the diamond matrix. In addition, graphite fragments (red shadow domains) accompanied by the island-like amorphous carbon (yellow shadow domains) are relatively homogeneously embedded in the diamond matrix, as shown in FIG. 1a. The diamond matrix phase (blue shadow domains) exhibits an interatomic spacing of 0.206 nm, corresponding to the {111} diamond spots in the fast Fourier transform (FFT) image (FIG. 1a, inset). The existence of this sp²/sp³ composite phase structure is also verified through other characterizations, including X-ray diffraction (XRD), X-ray photoelectron spectroscopy (XPS), and Raman spectroscopy (FIG. 5). The amorphous carbon zone with an average size of 3.55 nm (26% volume fraction) exhibits an interatomic spacing of approximately 0.338-0.357 nm. The graphite fragments zone with a size of 3.01 nm (17% volume fraction) shows an interatomic spacing of 0.338 nm, which corresponds to the graphite fragments {0002} at the arced position of the FFT image with a brighter contrast (FIG. 1a inset). The higher-magnification image (FIG. 1b) of the selected dashed zone in FIG. 1a indicates the possibility of the phase transition process between graphite and diamond. For instance, it is possible for a part of diamond to be transformed into graphite. The (1̅ 1 1̅) diamond plane oriented to the [1̅ 1 2] zone axis is directly transformed into the rectangular-like {0002} graphite plane oriented to the <1010> zone axis (FIG. 1b, red shadow domain 1) and subsequently into the fingerprint-like {0002} graphite plane (FIG. 1b, red shadow domain 2). This transformation process can be represented as d {111}→g {0002}. The transformation process of diamond to graphite is similar to that of graphite to diamond. In addition, intermediate amorphous carbon phase (FIG. 1b, yellow shadow domain) may be formed during the phase transition process. The amorphous carbon may continue to transform into graphite fragments to reach a more stable state (FIG. 1b, red shadow domains). A selected-area electron-diffraction (SAED) image reveals a broad amorphous carbon halo and face-centered cubic diamond crystalline spots oriented to the [1̅ 1 2] zone axis (FIG. 1c). In contrast, the graphite phase is not prominently shown in the figure, because of its low concentration and the overlapping of its {0002} planes with the amorphous carbon halo. The lower-magnification HRTEM images of different positions (FIG. 6a-6c) confirm that the nano composite phase structure exhibits a repeatable intermittent periodic distribution in at least a 2 μm-sized region throughout the sample. Furthermore, the phase transition process also promotes the generation of homogeneous and alternating tension and compression stress fields (FIG. 6d). The presence of the stress field and the nano composite phase structure are also supported by the shoulders observed near the (111) and (220) peaks in the XRD pattern (FIG. 5a). The composite phase structure and the corresponding stress fields could be the primary factor responsible for the enhancement of the diamond high-temperature oxidation resistance.

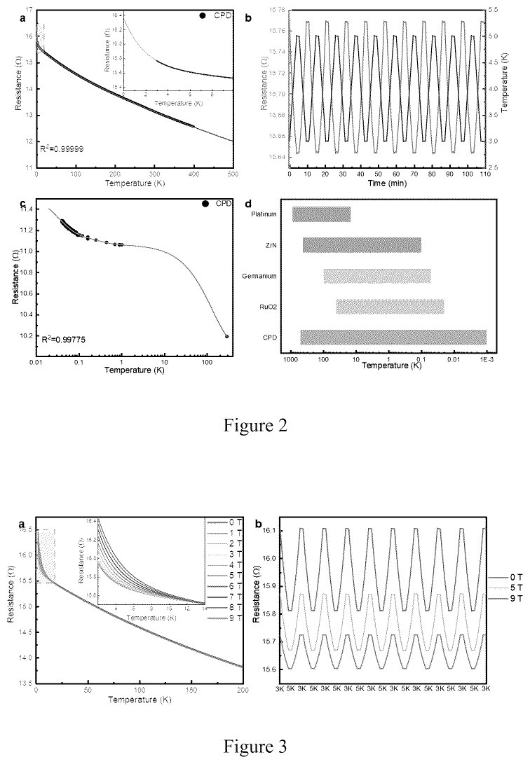

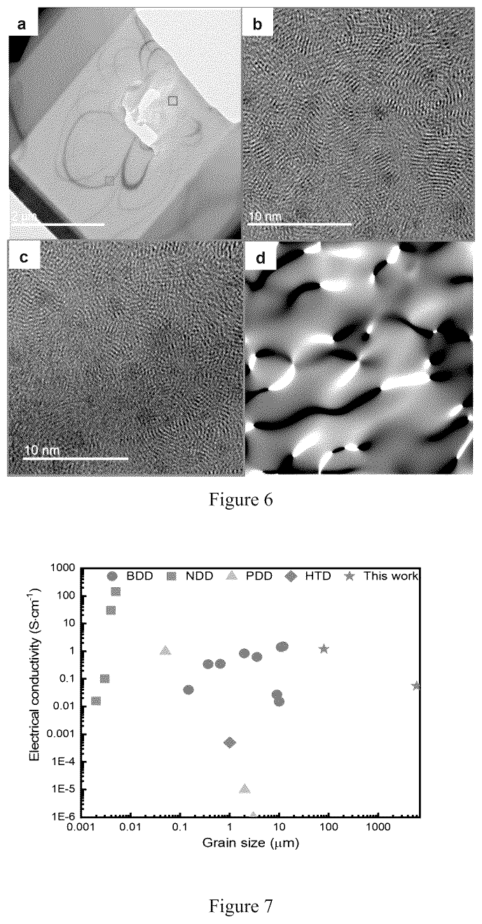

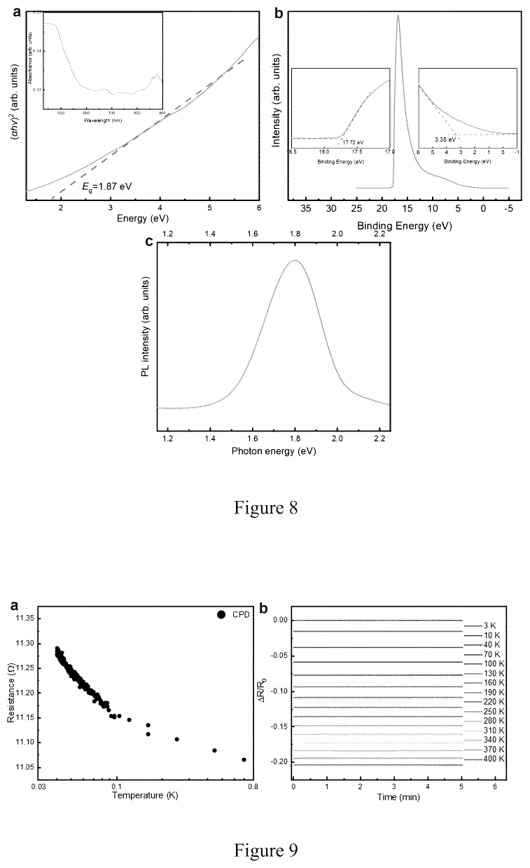

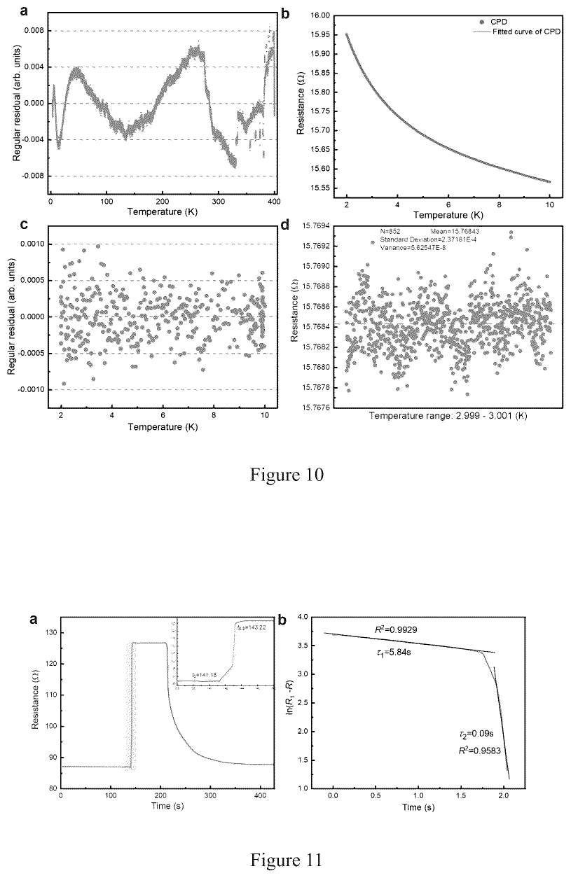

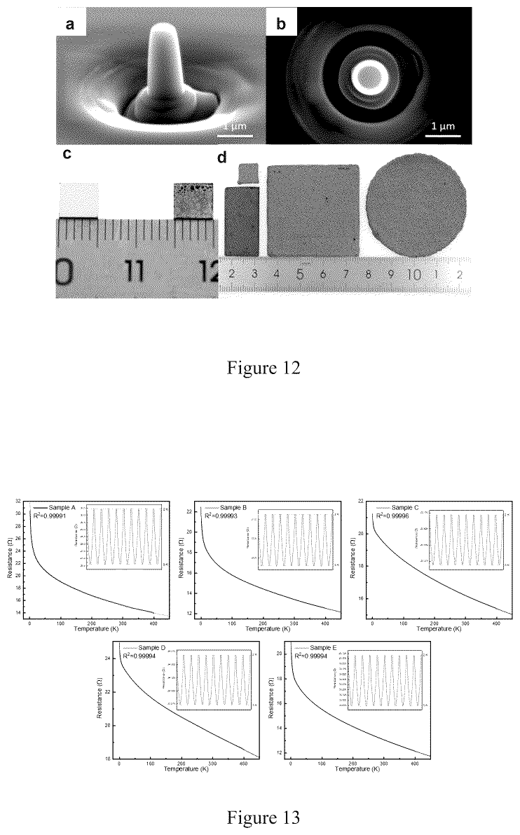

The conductivity of the CPD plays a crucial role in its application as a thermistor or temperature sensing material. High conductivity is essential for ensuring proper operation of the sensor at low temperatures while minimizing self-heating. The CPD shows an exceptional conductivity of 1.2 S·cm⁻¹ at room temperature, which is comparable to that of doping diamond (FIG. 7). This is due to the large number of sp²-hybridized amorphous carbons and graphite fragments distributed throughout the diamond matrix. These sp² carbons with delocalized π-electron system increases intrinsically electron transport of the CPD. Moreover, the amorphous carbon and graphite fragments coexistence phases randomly and uniformly distribute within the sp³ carbon phase. In other words, the amorphous carbon regions and graphite fragment regions coexist, and they randomly and uniformly distribute within the sp³ hybridized region. This can further increase the conductivity of the CPD by creating percolation pathways and forming a conductive network. In addition, the interfaces between sp² phases and a sp³ phase(s) have a certain number of defects. These structural irregularities can act as electron scattering centers, contributing to the electron mobility and transport enhancement. These constitutes the mechanical basis of the room-temperature electrical conductivity in CPD. Furthermore, the band gap and ionization energy of the CPD are characterized by UV-Vis diffuse reflectance spectroscopy (UV-Vis DRS) (FIG. 8a), ultraviolet photoemission spectroscopy (UPS) (FIG. 8b) and photoluminescence spectra (PL) (FIG. 8c). The band gap of the CPD is calculated to be about 1.87 eV and 1.80 eV by UV-Vis DRS and PL, respectively. The ionization energy of the CPD is obtained to be 7.84 eV by UPS. All these results are lower than the literature values for diamond (band gap value of 5.47 eV and ionization energy of 81 eV), which is also consistent with the above theory. FIG. 2a presents the R-T curve of a CPD sample with an initial resistance of 13.13179Ω (room temperature). The black curve displays the resistance data points acquired at a cooling rate of 2 K·min⁻¹. The curve exhibits a monotonically increasing characteristic throughout the entire test temperature range, signifying a negative temperature coefficient (NTC). Usually, at temperatures close to absolute zero, the resistivity of NTC materials increases sharply. Although this characteristic can enhance the sensitivity of the thermometer, it also restricts the thermometer from measuring lower temperatures. In contrast, the CPD does not encounter such issues. The CPD shows an approximately linear increase in resistance with decreasing temperature from ~400 to 10 K, and below 10 K, the resistance markedly increases. Nevertheless, even at a temperature as low as 3 K, the CPD maintains a very low resistance value, an unusual characteristic of semiconductor materials. This property guarantees that the CPD would not experience failure due to insulation. The data are fitted using a three-phase exponential decay function (Expdec3) and extrapolated to the temperature range of 0-500 K (indicated by the red curve). The coefficient of determination R² for the fitted curve is 0.99999, verifying the goodness of fit of the model. Furthermore, a dilution refrigerator was used to characterize the resistance changes of another CPD sample below 1 K. The result is shown in FIG. 2c and FIG. 9a. The resistance of the CPD also remains monotonically increasing within the 40 mK-1 K temperature interval, with no inflection points or abrupt changes. In addition, the R-T curve of the CPD below 1 K has a similarly high R² of 0.9978 when fitted using the Expdec3 function (FIG. 2c). The above results show that the physical properties of the CPD remain stable when it approaches absolute zero from room temperature. Moreover, the regular residuals, defined as the difference between the predicted and experimental resistance values, are primarily in the range of ±0.008 arb. units (FIG. 10a), which suggests that the theoretical calibration accuracy of the CPD could reach as high as 8 mK under a temperature range of 3 to 400 K. When only the data corresponding to temperatures below 10 K were fitted, the value of the regular residuals was less than ±0.001 arb. units (FIGS. 10b and 10c). Therefore, the CPD can achieve a temperature measurement resolution of 1 mK at <10 K, which is vital for the practical implementation of cryogenic temperature sensors. In the dynamic response test (FIG. 2b), the resistance of the CPD exhibits an excellent correspondence to the temperature. Furthermore, data are collected in the range of 2.999-3.001 K (FIG. 10d). The variance and standard deviation of 842 data points are 5.62547×10⁻⁸ and 2.37181×10⁻⁴ respectively, signifying a highly concentrated data distribution. These data are further divided into two intervals: 2.999≤T<3 K and 3≤T<3.001 K. The calculated intervals with 95% confidence for the former and latter are 15.76844-15.76849Ω and 15.76837-15.76841 Ω, respectively (Table 1). These two separate confidence intervals confirm that the temperature measurement accuracy of the CPD at 3 K can reach 1 mK. According to the fitted results obtained using the Expdec3 function (FIG. 2a inset), the resistance of the sample at 2 mK is computed as 16.36614Ω, and the resistance at 1 mK is 16.36652Ω. The difference between these two predicted values is larger than that between the resistance values in the temperature intervals of 2.999-3 K and 3-3.001 K. This proves that the theoretical detection temperature of the CPD can reach 1 mK, a level not yet achieved by any existing cryogenic temperature sensor. FIG. 9b displays the resistance response over time with a temperature increasing from 3 to 400 K. It demonstrates the excellent stability of the CPD during temperature measurements. FIG. 2d compares the temperature measurement ranges of the CPD with those of other cryogenic thermometers. The CPD demonstrates significant advantages as it could measure temperatures at the mK level. In addition, as shown in FIG. 11, from putting the CPD into liquid nitrogen from room temperature until (the temperature becomes) stable, the corresponding response time is 3.48 s. The time taken to respond to 90% of a step change in temperature (T_{0.9}) is only 2.04 s. Such a capability can facilitate the translation of quantum computing, quantum simulation, and related technologies from research to practical applications. Furthermore, the CPD can be synthesized at various scales, for examples, a micrometer-scale CPD probe (Ø=1 μm) fabricated by focused ion beam (FIB), a millimeter-scale bulk CPD and a complex structure with the CPD via 3D printing (FIG. 12). These variously sized samples are suitable for a range of applications. FIG. 13 further illustrates the repeatability/reproducibility of CPD samples with different sizes.

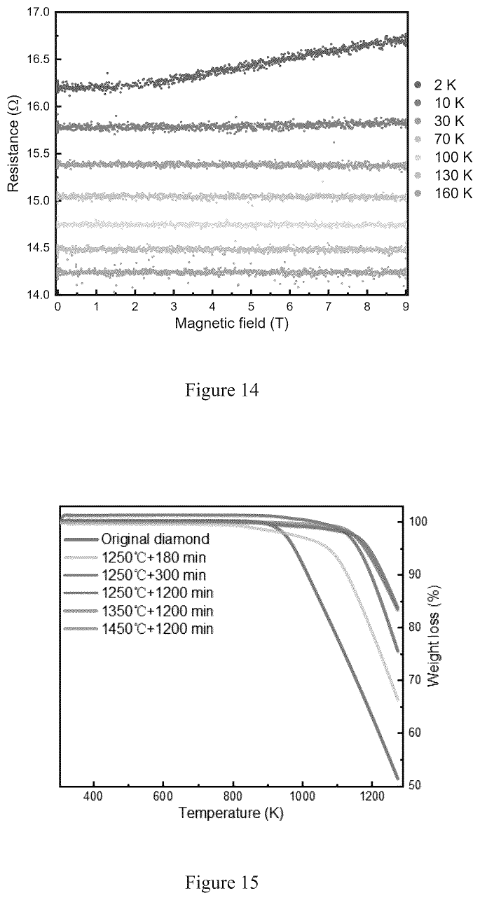

Cryogenic temperature measurements are considerably limited by the presence of magnetic fields. These fields induce reversible calibration shifts, leading to inaccurate temperature readings. These shifts are temporary, and the sensors revert to their zero-field calibration upon the removal of the magnetic field. The sensitivity of the sensor to magnetic fields considerably influences its application value. FIG. 3a, FIG. 3b, and FIG. 14 depict the resistance changes of the CPD in a magnetic field environment. Under temperature conditions of >14 K, the CPD is almost insensitive to magnetic field changes (FIG. 3a, FIG. 14). Even at <14 K, the magnetoresistance changes of the CPD remain relatively small. At a temperature of 2 K and under a strong magnetic field of 9 T, the resistance shifts rate of the CPD is only ~3% (FIG. 3a inset). The insensitivity of the CPD to magnetic fields is significant in applications such as nuclear magnetic resonance. In addition, the CPD displays linear magnetoresistance properties under magnetic fields (FIG. 14). This characteristic can simplify the calibration process for temperature sensors in magnetic field environments and endows the CPD with potential applications in novel quantum linear magnetoresistive devices, particularly magnetic sensors.

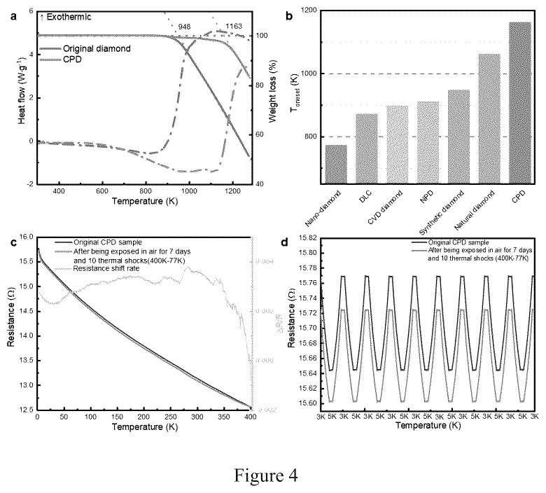

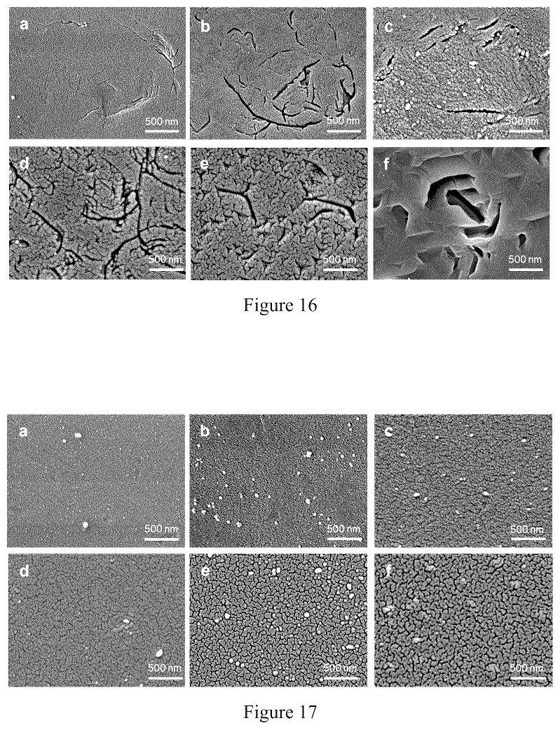

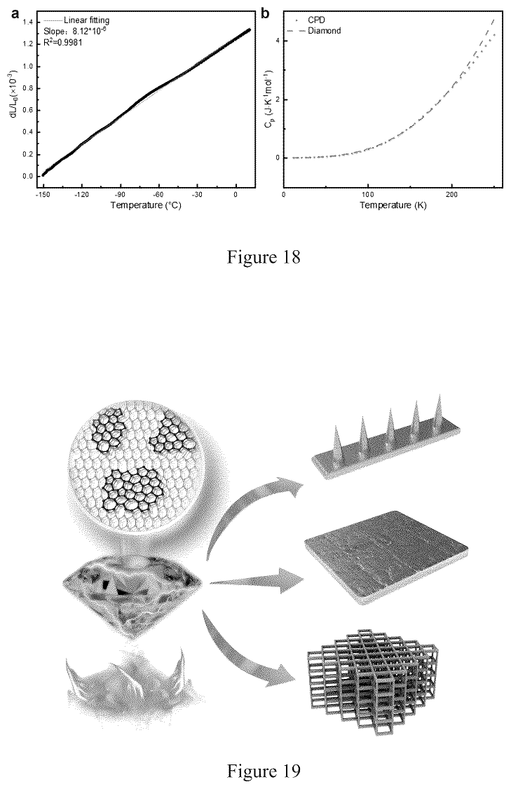

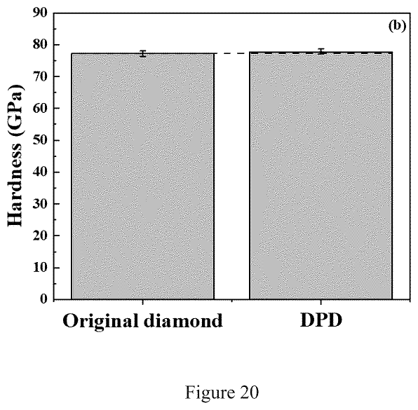

Cryogenic temperature sensors are also operated and stored under room temperature or high temperature conditions. The resistance of the temperature sensor may undergo shifts following the measurement of a large temperature difference. This significantly challenges the thermal stability of the cryogenic temperature sensor, particularly for carbon-based sensors. The inventors investigated the intrinsic thermal stability of the CPD (FIG. 4a) and its resistance variation after thermal cycling (FIG. 4c, 4d). The oxidation of diamonds in air typically encompasses two processes: direct diamond oxidation and diamond oxidation after graphitization. Graphite and other sp²-hybridized carbon materials typically exhibit a higher susceptibility to oxidation in air than sp³-hybridized diamonds. Consequently, the research on enhancing the oxidation resistance of diamonds often centers on diamond graphitization-prevention strategies. The inventors' study found that the incorporation of a sp²-hybridized carbon phase within the diamond structure do not reduce the onset oxidation temperature. Instead, the presence of the sp²-hybridized carbon phase significantly increases onset oxidation temperature of the CPD: the onset oxidation temperatures of the original diamond and the CPD were 948 K and 1163 K, respectively (FIG. 4a). The CPD exhibits greater thermal stability than other diamond materials (FIG. 4b). This finding contradicts the commonly held belief that the presence of sp²-hybridized carbon bonds reduces thermal stability. It is believed that these anomalous characteristics may be related to the structure of the CPD. Compared to traditional graphitized diamond, the microstructural characteristics of CPD is sp³ carbon dominated (>50% sp³ carbon) with sp² nano carbon phase uniformly discrete distributed. This microstructure avoids the existence of larger continuous sp² carbon bonds and protects sp² nano carbon phase from direct contact with oxygen, which can inhibit the sp² carbon clusters increasing at high temperatures. This study is the first instance in which the high-temperature oxidation resistance of diamond is enhanced without the application of high-pressure treatments, which were adopted in previous research. FIG. 15 illustrates the impacts of different heat treatment conditions on the thermal stability of the CPD. With increasing heat treatment duration, the thermal stability of the CPD is significantly enhanced, while the increase in the heat treatment temperature from 1250 to 1550 °C negligibly influences the thermal stability of the CPD. Currently, no definitive explanation exists for this unusual phenomenon. The inventors believe that the uniform distribution of the sp²-hybridized carbon phase within the diamond matrix (FIG. 1a, FIGS. 6b and 6c) increase the number of lattice distortions and the stress field in the CPD. Moreover, the sp² carbon phase has a greater thermal expansion coefficient than that of diamond. The thermal expansion of those sp² nano carbon phases further increase the internal stresses of CPD, which is the main factor to enhance the diamond's resistance to high-temperature oxidation resistance performance. The SEM images shows the differences in the oxidation processes between original diamond and the CPD (FIGS. 16 and 17) more visually. The presence of these lattice distortions and the stress field augments the nanoscale properties of the diamond, counteracts the graphitization-induced reduction in strength, and inhibits the graphitization and oxidation processes of the diamond in air.

The significant improvement in the high-temperature oxidation resistance demonstrates the excellent thermal stability of the CPD. FIG. 4c compares the resistance changes between the original CPD sample and the sample exposed to air for seven days without any protection and then subjected to 10 thermal shocks (77-400 K). Although the overall resistance of the sample increased slightly after thermal shocks, the change rates was <0.4%. These results demonstrate that the CPD exhibits exceptional electrical resistance stability in response to temperature changes, consistent with the dynamic response test results (FIG. 4d). After thermal shocks, the R-T trend of the CPD remains unchanged.

In summary, the inventors successfully synthesized the CPD with remarkable electrical properties and thermal stability through a straightforward approach. The CPD has demonstrated its capability and stability as a temperature sensing material in extreme environments, verifying the inventors original design intention. The lowest temperature measurement limit of the CPD reaches 1 mK, which can contribute to the advancement of low-temperature physics and quantum physics. In addition, the composite phase structure considerably influences the diamond properties. This nanoscale crystal reconstruction allows for the transformation of the diamond from an exceptionally hard material to a functional material. The successful synthesis of the CPD will create new paths towards diamond applications in precision measurement, quantum computing, medical devices, and space technology.

### Methods

### Sample Synthesis

The original diamond is a commercially available synthetic diamond powder provided by Tianjian Carbon Material Co., Ltd., China, and belongs to the Type 1b diamond. The diamond particles (80 μm) are thoroughly mixed with acrylic acid ammonium salt polymer (≥99%), acrylamide (≥99%), N,N′-Methylenebisacrylamide (≥99%), 2-hydroxy-2-methylpropiophenone (≥99%), diphenyl(2,4,6-trimethylbenzoyl)phosphine oxide (≥99%) and water in a specific weight ratio of 60:3.3:2.4:4:0.24:7.3. 3D printing is carried out using a DIW 3D printer (3D Bio-Architect® Work Station) from Regenovo Biotechnology Co., Ltd., China. The printing is carried out with a line width of 0.4 mm, utilizing a closely spaced pattern that can be achieved through a crosshatch printing method. During the printing process, preliminary curing is accomplished by exposure to a 365 nm ultraviolet lamp. Then the sample is dried at 80 °C in an oven (Froilabo, France) for 4 hours. Subsequently, it is sintered in an Argon (Ar) atmosphere at 1250 °C and atmospheric pressure to obtain the CPD. All samples are ultrasonically cleaned in anhydrous ethanol. The sintering process is conducted in a tube furnace (BTF-1700C, ANHUI BEQ EQUIPMENT TECHNOLOGY CO., LTD., China). Unless otherwise specified, the sintering time for the samples presented in the manuscript is 1800 min. “≥99%” refers to the purity of a product, i.e. the product has a purity of 99% or more.

### Structure, and Phase Characterization.

The microstructures of the CPD are investigated via HRTEM and SAED using a transmission electron microscope (JEM-2011F, JEOL Ltd., Japan) with an accelerating voltage of 200 kV. To depict the distribution of the amorphous carbon zone and graphite fragments zone in CPD, pseudo-color calibration of the phase regions of multiple HRTEM images is performed. Then employed ImageJ is employed to quantitatively analyze the corresponding areas, ultimately determining the content of each phase. The stress field of the nano composite phase structure is characterized via geometric phase analysis using the background-filtered image in Strain++ software. The component phases and structure of the CPD are characterized via TEM, XRD (Smartlab, Rigaku, Japan) with CuK_{α} radiation (I=1.541838 Å), XPS (PHI 5802, PHI, USA), and Raman spectroscopy (alpha300 R, WITec, Germany) with an excitation wavelength of 532 nm. Prior to XPS measurement, a 0.5 nm-thick Au coating is sputtered onto the samples to calibrate all spectra by shifting the Au 4f-7 peak to 84.0 eV.

### Property Measurements.

The conductivity of the sample is measured using a four-point probe meter (CXT2665, Changzhou Xinyang Electronic Technology Co., Ltd., China), with a distance of 1.59 mm between the probes. The UV-Vis DRS is measured by PerkinElmer Lambda950. The band gap of CPD is derived from the absorption spectra using the Tauc plot method. The UPS is measured by Escalab Xi+. A helium gas discharge lamp emitting light in the ultraviolet region (He I, Eₕᵥ=21.22 eV) is used to measure the valence band spectra. The PL spectra of CPD is measured by Edinburgh FLS1000, with a laser wavelength of 532 nm. The resistance values of the CPD at different temperatures and magnetic fields are measured using a physical property measurement system (Quantum Design PPMS® DynaCool™, Quantum Design Inc., USA) equipped with a Cernox™ temperature sensor. The high-temperature oxidation resistance of the CPD is studied using a thermal analysis system (TGA/DSC 3+, Mettler Toledo, Switzerland) in air with a heating rate of 5 K min⁻¹. The measurements are conducted in air over a temperature range of 20-1000 °C.

### SUPPLEMENTARY FIGURES AND TABLES

FIG. 5 shows structural characterization of the CPD. a X-ray diffraction (XRD) patterns of the original diamond and the CPD. Left inset shows the magnified sections of the XRD patterns for the CPD within the 18°-32° two-theta range showing a weak broadened peak at approximately 2θ=26°. This peak can be attributed to the (002) reflection of carbon atoms in a hexagonal crystalline arrangement, suggesting the existence of an amorphous carbon structure. Middle and right insets show the (111) and (220) peaks of CPD which display a minor shift of ~0.1°, accompanied by the emergence of shoulder peaks on the left (indicated by gray arrows). This indicates a change in the lattice constant of the sample and suggests the possibility of lattice distortion at the nanometer scale. Similar phenomena have been reported for a nanotwinned diamond. b Raman spectra of the CPD. The sharp peak at 1332 cm⁻¹, representing the first-order Raman spectrum line of diamond, corresponds to the symmetric stretching vibrations of sp³-hybridized carbon atoms within the diamond lattice. The original diamond has a diamond characteristic peak width at the full width at half maximum (FWHM) of 8.3 cm⁻¹. In comparison, the peak of the CPD is broadened to 31.4 cm⁻¹, which is also considered a manifestation of the lattice distortion, splitting, and rearrangement of diamond crystals. The G band at 1583 cm⁻¹ is a characteristic band of the sp²-hybridized carbon phase, with an FWHM of 120 cm⁻¹, which also reflects the presence of a sp²-hybridized carbon phase within the CPD. The peak at 2915 cm⁻¹ is referred to as the D+G peak, which arises from inter-valley scattering of a phonon near the K point, in-valley scattering of a phonon near the K′ point, and the inter-valley scattering of a defect. This peak is related to the degree of disorder in the sp² carbon, its appearance indicates the occurrence of a significant number of sp²/sp³ bond transitions within the CPD crystal. c X-ray photoelectron spectra of the C Is region of the CPD. The deconvoluted peaks at 284.3 and 285.1 eV correspond to sp²-hybridized carbon bonds and sp³-hybridized carbon bonds, respectively.

FIG. 6 shows uniform distribution of nano dual-phase structure at the micrometer scale. a 8000 K magnification of the thin area of the CPD sample prepared with focused-ion beam (FIB) technology with a size of approximately 2×2 μm². b and c High-resolution transmission electron microscopy (HRTEM) images of the selected region marked in the FIB sample showing the repeatable intermittent periodic distribution of the nano dual-phase structure. d Geometric phase analysis for background-filtered image (FIG. 1b) showing the stress field of the nano dual-phase structure, where tension (white) and compression stress (black) alternately emerge and meet, corresponding to diamond and graphite as well as amorphous carbon transition region.

FIG. 7 shows comparison of the conductivity of the CPD with those of other conductive diamonds: boron-doped diamond (BDD), nitrogen-doped diamond (NDD), phosphorus-doped diamond (PDD) and hydrogen-terminated diamond (HTD). In single-crystal diamond, the presence of numerous strongly bonded carbon atoms (σ-bonds) results in extremely high activation energy, making it challenging to form an n-type diamond through nitrogen or phosphorus doping. Therefore, diamond doping is usually conducted using the smallest possible grain size. The conductivity of the CPD powder with a particle size of 80 μm is found to reached 1.2 S·cm⁻¹, while the conductivity of the single-crystal diamond with dimensions of 5×5×1 mm³ is measured as 0.05 S·cm⁻¹.

FIG. 8 shows spectroscopic analysis of energy band information of CPD: a UV-Vis spectrum. Insert: The UV-Vis plots are processed using the Tauc-plot method. The calculated band gap of CPD is 1.87 eV. b UPS spectrum. c PL spectrum.

FIG. 9 shows performance of the temperature sensing characteristics of CPD. a Resistance changes of CPD from 40 to 800 mK. b Change rates of resistance response over time at different temperatures. Here, R₀ is the average resistance measured at 3 K.

FIG. 10 shows statistical analysis of the resistance discreteness of the CPD. a The regular residuals between the data fitted by the Expdec3 function and the measured data points. b The results of the seventh-order polynomial fitting for the data measured in the temperature range of 2-10 K. Red line: experimental data points; blue line: seventh-order polynomial fitting curve. Inset table: the fitting curve parameters and associated statistical errors (R²). c The corresponding regular residual distribution to b. d Statistical analysis of the distribution of the resistance values of the CPD obtained at ~3 K. During the dynamic response test, the resistance readings in the 2.999<T<3.001 K interval are recorded and compared with the reference value obtained from the Cernox™ cryogenic temperature sensor. The resistance values were analyzed to calculate the confidence interval, variance, and standard deviation, as shown in Table 1.

FIG. 11 shows the response time of CPD during rapid temperature changes. a Response time of CPD when cooling from room temperature to liquid nitrogen temperature. b The calculated thermal time constant of CPD.

The thermal time constant (TTC) is a characteristic constant for the response time of thermistor material. The heat balance equation for an isotropic solid without internal heat sources can be represented as:

−ρ·Cₚ·VdT=α·A·(T−T₁)dt (1)

As the direct measurement data herein is resistance, and resistance corresponds directly to temperature, all parameters related to T in the above equation have been replaced with R:

−ρ·Cₚ·VdR=α·A·(R−R₁)dt (2)

In Eq. (2), A represents the sample's surface area, ρ is the sample's density, Cp and V are the specific heat capacity and volume of the sample, respectively. α is the heat transfer coefficient between the sample and the surrounding medium, and it can be influenced by various factors, including the shape and size of the sample, as well as the method of contacting with the surrounding medium, the form and flow rate of the medium, and more.

When the sample is moved from air to liquid nitrogen, the resistance changes from R₀ to R₁. The relationship between t and R at any given moment during this process can be obtained by integrating equation (2), resulting in:

$$\frac{R - {R}_{1}}{{R}_{1} - {R}_{0}} = - {e}^{- \frac{t}{τ}} \qquad ( 3 )$$

Where τ is the thermal time constant,

$$τ = \frac{ρ {C}_{p} V}{α A} \qquad ( 4 )$$

Eq. (3) can be further written as:

$${R}_{1} - R = ( {R}_{1} - {R}_{0} ) {e}^{- \frac{t}{τ}} \qquad ( 5 )$$

Taking the natural logarithm of both sides of Eq. (5), it can be further expressed as:

$$ln ( {R}_{1} - R ) = ln ( {R}_{1} - {R}_{0} ) - \frac{t}{τ} \qquad ( 6 )$$

Clearly, plotting In (R₁−R) against t results in a linear relationship, where the slope of the line corresponds to

$$- \frac{1}{τ} ,$$

then getting the value of τ. As shown in FIG. 10, the curve is not a single line; instead, it is composed of two linear segments, which is due to the reasons mentioned earlier. Separate curve fittings are conducted for the two segments, yielding τ₁ and τ₂. τ₁ is 5.84 seconds, and τ₂ is 0.09 s. τ₁ is situated within the region significantly affected by the intermediate medium (water vapor), leading to a substantial overestimation of its value. In contrast, t_{0.26} can still be reasonably regarded as the starting point of the step-change temperature. Therefore, τ₂ holds greater reference value.

FIG. 12 shows images of actual CPD samples, a and b A pillar-like CPD probe, Ø=1 μm, prepared via FIB. c A CPD sample prepared from a (110) single-crystal diamond, with dimensions of 5×5×1 mm³. d 3D-printed CPD samples, printed from diamond powder with a particle size of 80 μm.

FIG. 13 shows R-T curves of CPD samples with different sizes: sample A (8×4 mm²), sample B (4×4 mm²), sample C (8×5 mm²), sample D (10×5 mm²), and sample E (5×5 mm²). All samples show NTC characteristics. There are slight differences in resistance values among samples of different sizes. On one hand, the differences in resistance are expected due to the varying sizes of the samples. On the other hand, manual operations inherently introduce various unavoidable sources of error, so these variations are understandable.

FIG. 14 shows stability of the CPD under magnetic fields. The resistance of the CPD with increasing applied magnetic fields from 0 to 9 T at different cryogenic temperatures. At temperatures above 10 K, the CPD is almost insensitive to external magnetic fields. At 2 K, the resistance of the CPD shifts when the magnetic field exceeds 2 T, and the CPD exhibits a linear magnetoresistance feature.

FIG. 15 shows effect of heat treatment conditions on the thermal stability of the CPD. Thermogravimetric curves with different heat treatment processes. With an increase in the heat treatment time, the onset thermal oxidation temperature of the CPD increases significantly, and the maximum value is reached at 1200 min. The effect of heat treatment temperature on the thermal stability of the CPD is not significant.

FIG. 16 shows oxidation of original diamond at different temperatures. a 700 °C, 3 min. b 900 °C, 3 min. c 1000 °C, 3 min. d 1000 °C, 10 min. e 1000 °C, 30 min. f 1100 °C, 3 min.

FIG. 17 shows oxidation of CPD at different temperatures. a 700 °C, 3 min. b 900 °C, 3 min. c 1000 °C, 3 min. d 1000 °C, 10 min. e 1000 °C, 30 min. f 1100 °C, 3 min.

FIG. 18 shows thermal properties of CPD. a The thermal expansion coefficient of CPD. b The heat capacity of CPD. According to the Debye model, as the temperature approaches absolute zero, the heat capacity of CPD also approaches zero. Based on experimental values, at 25 K, CPD's heat capacity is already less than 0.01 J·K⁻¹ mol⁻¹. CPD's low heat capacity and low resistance can effectively reduce the self-heating effect during temperature measurements.

TABLE 1
Descriptive statistics of the collected resistance
data points when the CPD is tested at 3 K.

| | | | | | Lower | Upper |
|---|---|---|---|---|---|---|
| | | | Standard | | 95% CI | 95% CI |
| Interval | N total | Mean | Deviation | Variance | of Mean | of Mean |
| 2.999 ≤ T < 3 | 401 | 15.76847 | 2.4066 × 10⁻⁴ | 5.79171 × 10⁻⁸ | 15.76844 | 15.76849 |
| 3 ≤ T < 3.001 | 451 | 15.76839 | 2.28934 × 10⁻⁴ | 5.2411 × 10⁻⁸ | 15.76837 | 15.76841 |

TABLE 2
Cryogenic temperature sensor performance indicators. Except for the CPD data, all
data are sourced from the public disclosures of Lake Shore Cryotronics, Inc.

| | | | | | | Resistance |
|---|---|---|---|---|---|---|
| Cryogenic | Resolution | Lower | Upper | Sensor | Resistance | shift rate at |
| temperature | at 2 K | temperature | temperature | size | at 2 K | 2 K and 8 T |
| sensor | (k) | limit (k) | limit (k) | (mm³) | (Ω) | (%) |
| CPD | 0.001 | 0.001 | 500 | 2 × 10⁻³ | 15.95 | 2.6 |
| Cernox ™ | 0.005 | 0.1 | 420 | 0.411 | 413.26 | 3.1 |
| Interchangeable | 0.005 | 0.05 | 40 | 1.2 | 1726 | 7.9 |
| Rox ™ | | | | | | |
| Germanium | 0.006 | 0.05 | 100 | 72.9 | 19.32 | 60 |
| Silicon Diodes | 0.12 | 1.4 | 500 | 0.031 | * | * |
| Platinum | 1.3 | 14 | 873 | 24.115 | * | * |

### EXAMPLES

### Example 1

Mix diamond powders (with a particle size of 80 μm) with acrylamide, phenylbis(2,4,6-trimethylbenzoyl) and ammonium polyacrylate at a mass ratio of 30:5:1:1 to prepare an organic-diamond precursor. The diamond powders act as a carbon raw material, acrylamide acts as a binder, phenylbis(2,4,6-trimethylbenzoyl) acts as an initiator, and ammonium polyacrylate acts as a thickener. Process the precursor into a desired shape with a desired thickness by 3D printing, and then cure the precursor by ultraviolet light with a wavelength of 345 nm. The curing time required may depend on the sample's size. For instance, smaller samples require a shorter time and larger samples require a longer time. For example, a sample with 3 layers with an area of 1 cm×1 cm may usually be cured in a few seconds. Large size and/or multiple-layered samples (e.g. samples with more than 10 layers) need to be cured layer by layer. Heat the cured precursor in a tube furnace at 1500 °C with an argon atmosphere with a heating rate at 10 °C·min⁻¹ and a holding time of 3 hours, resulting in a 3D printed CPD material sample. Fabricate a temperature sensor from the CPD material.

### Example 2

Mix a bulk single crystal diamond with (with a size of 5 mm×5 mm×1 mm) with methyl methacrylate and polyacrylamide at a mass ratio of 5:5:1 to prepare an organic coated diamond precursor. The bulk single crystal diamond acts as a carbon raw material, methyl methacrylate acts as a binder, and polyacrylamide acts as a thickener. Cure the precursor by ultraviolet light with a wavelength of 345 nm. Heat the precursor at 1200 °C with an argon atmosphere with a heating rate is 5 °C·min⁻¹ and a holding time of 60 hours, resulting in a bulk conductive CPD material sample, as shown at the right side of Figure c in FIG. 12. The dimensions of the CPD sample are 5 mm×5 mm. The CPD material can be directly used as a conductive element.

### Example 3

As an example, an as-prepared CPD may have a resistivity of about 0.893 ohm·cm and a conductivity of 1.119 S/cm.

### Example 4

FIG. 1a shows a TEM image of an embodiment of the CPD material of the present invention showing a sp²-hybridized phase (or multiple sp²-hybridized regions) distributed throughout a sp³-hybridized phase (or a sp³-hybridized region). The figure shows a sp³-hybridized region, 10 of the CPD material, which can also be called a sp³-hybridized diamond region or simply, a diamond region. The configurations of carbon atoms in the sp³-hybridized region may be purely or substantially in a sp³-hybridized diamond structure. The sp³-hybridized region, 10 exhibits an interatomic spacing of about 0.206 nm. The figure also shows some island-like carbon regions, 20 (or island-like carbon clusters) of the CPD material. The island-like carbon regions, 20 may also be called non-diamond regions or (a) non-diamond phase(s), implying that the configurations of carbon atoms in the island-like carbon regions, 20 may not be purely or substantially in a sp³-hybridized diamond structure. The island-like carbon regions, 20 are distributed throughout the sp³-hybridized region, 10. The island-like carbon regions, 20 have different sizes and/or shapes. Some of the island-like carbon regions, 20 are separated from each other while some of the island-like carbon regions, 20 may be connected among each other, throughout the sp³-hybridized phase, 10.

The island-like carbon regions, 20 may include a sp²-hybridized region, 21 or multiple sp²-hybridized regions, 21. The configurations of carbon atoms in the sp²-hybridized regions may be purely or substantially in a sp²-hybridized carbon structure, or in a sp²-hybridized graphite structure. The sp²-hybridized regions, 21 may be in form of one or more graphite fragments. The sp²-hybridized regions, 21 may contribute to the electrical conductivity of the CPD material.

In some embodiments, the CPD may have multiple amorphous carbon regions. In this example, the island-like carbon regions, 20 may also include amorphous carbon regions, 22 apart from the sp²-hybridized regions, 21. Unlike the configurations of the sp³-hybridized region or of the sp²-hybridized regions, the configurations of carbon atoms of the amorphous carbon regions, 22 have different coexisting bonding configurations, such as sp¹, sp² and/or sp³ hybridized carbon configurations. In FIG. 1a, one of the island-like carbon regions, 20 is labelled as an example for illustration. The labelled island-like carbon region, 20 is located close to the bottom left side of FIG. 1a. There are other island-like carbon regions next to and separated from the labelled island-like carbon region, 20, of different sizes and shapes. FIG. 1a uses a boundary line to frame and distinguish the island-like carbon region, 20 (as well as the other island-like carbon regions) from the sp³-hybridized region, 10. FIG. 1a represents the sp³-hybridized region with a blue color, amorphous carbon regions with a yellow color and the sp²-hybridized regions with a red color. The island-like carbon regions, 20 including graphite fragments (marked in red) are relatively homogeneously embedded in the sp³-hybridized region (marked in blue). In an island-like carbon region, 20, there may be one or more sp²-hybridized regions, 21 and in addition, one or more the amorphous carbon regions, 22. An amorphous carbon region, 22 adjoins at least respective one of the sp²-hybridized regions. In an island-like carbon region, 20, there are irregularities at the interface between the sp³-hybridized region and the sp²-hybridized regions. In other term, the boundaries or the surfaces of a sp²-hybridized region or cluster are irregular. A sp²-hybridized region may include a peripheral portion protruding from its main body and extending to the sp³-hybridized regions.

In some embodiments, it is preferable to have a lower ratio of the portion (wt %) of the amorphous carbon regions compared to the portion (wt %) of the sp³-hybridized region plus the sp²-hybridized regions in the CPD material. In other terms, it is preferable to have less amorphous carbon regions in the CPD material.

FIG. 1c shows an image of selected area electron diffraction (SAED) of an embodiment of the CPD material of the present invention. The SAED image reveals a broad amorphous carbon halo and face-centered cubic diamond crystalline spots oriented to the zone axis. It should be noted that this image is a part of cross-sectional view of the CPD material, not the surface, this is important for understanding the concepts of evenly distributing and dual-phase (composite phase).

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

What is claimed is:

1. A composite phase diamond material, wherein the composite phase diamond material comprises a sp³-hybridized region and one or more sp²-hybridized regions, wherein the sp²-hybridized regions are located in the sp³-hybridized region.

2. The composite phase diamond material according to claim 1, wherein the sp²-hybridized regions are spaced from each other in form of one or more clusters distributed in the sp³-hybridized region.

3. The composite phase diamond material according to claim 1, wherein the composite phase diamond includes one or more amorphous carbon regions.

4. The composite phase diamond material according to claim 3, at least one of the amorphous carbon regions adjoins at least respective one of the sp2-hybridized regions to form a cluster.

5. The composite phase diamond material according to claim 4, wherein the cluster is spaced from another cluster.

6. The composite phase diamond material according to claim 1, wherein the composite phase diamond comprises irregularities at the interface between the sp³-hybridized region and the sp²-hybridized regions.

7. The composite phase diamond material according to claim 1, the composite phase diamond material is electrically conductive.

8. The composite phase diamond material according to claim 1, the composite phase diamond material is insensitive to magnetic field; in particular, the composite phase diamond material is insensitive to magnetic field at a temperature from about −263 °C to about 200 °C.

9. The composite phase diamond material according to claim 1, the composite phase diamond material comprises:
from about 50 vol. % to about vol. 90% of the sp³-hybridized region and from about 10 vol. % to about 50% of the sp²-hybridized regions, based on the total volume of the composite phase diamond material; or
from about 50 vol. % to about vol. 70% of the sp³-hybridized region and from about 30 vol. % to about 50% of the sp²-hybridized regions, based on the total volume of the composite phase diamond material; or
from about 50 vol. % to about vol. 60% of the sp³-hybridized region and from about 40 vol. % to about 50% of the sp²-hybridized regions, based on the total volume of the composite phase diamond material.

10. The composite phase diamond material according to claim 3, the composite phase diamond material comprises:
from about 50 vol. % to about vol. 90% of the sp³-hybridized region, from about 10 vol. % to about 50% of the sp²-hybridized regions and from about 10 vol. % to about 50% of the amorphous carbon regions, based on the total volume of the composite phase diamond material; or
from about 50 vol. % to about vol. 60% of the sp³-hybridized region, from about 20 vol. % to about 40% of the sp²-hybridized regions and from about 10 vol. % to about 30% of the amorphous carbon regions, based on the total volume of the composite phase diamond material.

11. A method for fabricating a composite phase diamond material according to claim 1, the method comprising the steps of:
a) providing a precursor comprising a carbon raw material;
b) providing a polymer formation composition comprising a polymerizable binder; and
c) heating the precursor and the polymer formation composition to form the composite phase diamond material.

12. The method of fabricating a composite phase diamond material according to the claim 11, wherein the method comprises a polymerization step wherein the polymerizable binder at least partially polymerizes, prior to the heating step c).

13. The method of fabricating a composite phase diamond material according to claim 12, the method comprises a mixing step for mixing the polymer formation composition with the precursor prior to the polymerization step.

14. The method of fabricating a composite phase diamond material according to claim 11, wherein the carbon raw material comprises an original diamond; optionally, wherein the carbon raw material further comprises an amorphous carbon and/or a graphite.

15. The method of fabricating a composite phase diamond material according to claim 11, wherein the carbon raw material comprises a material selected from the group consisting of an original diamond, an amorphous carbon, a graphite, and a combination thereof.

16. The method of fabricating a composite phase diamond material according to claim 14, wherein the heating step c) comprises a step of transforming part of the original diamond to graphite fragments, or wherein from about 10 vol. % to about 50% of the original diamond are transformed to the graphite fragments.

17. The method of fabricating a composite phase diamond material according to claim 14, wherein the step of transforming part of the original diamond to graphite fragments comprises a step of transforming part of the original diamond to amorphous carbon.

18. The method of fabricating a composite phase diamond material according to claim 11, wherein the polymer formation composition comprises an initiator.

19. The method of fabricating a composite phase diamond material according to claim 11, wherein the carbon raw material is in a form selected from the group consisting of a powder, a film, a bulk, and a combination thereof.

20. The method of fabricating a composite phase diamond material according to claim 11, wherein the composite phase diamond material is in a form selected from the group consisting of a powder, a film, a bulk, and a combination thereof.

21. The method of fabricating a composite phase diamond material according to claim 11, wherein the binder comprises an organic binder; or wherein the binder comprises an organic material selected from the group consisting of ammonium polyacrylate, methyl methacrylate, acrylamide, di(propylene glycol) diphenylate, N-hydroxyethyl acrylamide and styrene, and a combination thereof.

22. The method of fabricating a composite phase diamond material according to claim 18, wherein the initiator comprises a photosensitive initiator; or wherein the initiator is selected from the group consisting of N,N′-Methylenebisacrylamide, 2-hydroxy-2-methylpropiophenone, triphenylborane, 1-pyrroline-5-carboxylic acid, 2-hydroxy-2-methyl-1-phenyl-1-propanone, phenyl bis(2,4,6-trimethyl benzoyl), diphenyl(2,4,6-trimethylbenzoyl)phosphine oxide and a combination thereof.

23. The method of fabricating a composite phase diamond material according to claim 18, wherein the initiator comprises two different photosensitive initiators.

24. The method of fabricating a composite phase diamond material according to claim 11, wherein the polymer formation composition further comprises a thickener; or, wherein the thickener comprises a polymer; or wherein the thickener is water soluble; or wherein the thickener is silicon free; or wherein the thickener is metal ion free.

25. The method of fabricating a composite phase diamond material according to claim 24, wherein the thickener is selected from the group consisting of polyacrylamide, sodium carboxymethyl cellulose, poly(acrylate ammonium), and polyvinyl alcohol, and a combination thereof.

26. The method of fabricating a composite phase diamond material according to claim 11, wherein the binder is a water soluble binder and/or an oil soluble binder.

27. The method of fabricating a composite phase diamond material according to claim 18, wherein the initiator comprises a photosensitive initiator, or wherein the initiator absorbs light with a wavelength from about 245 nm to about 400 nm.

28. The method of fabricating a composite phase diamond material according to claim 11, wherein the heating step further comprises a sintering step.

29. The method of fabricating a composite phase diamond material according to claim 11, wherein the heating step takes place at a temperature from about 900 °C to about 2200 °C, or from about 900 °C to about 1600 °C.

30. The method of fabricating a composite phase diamond material according to claim 11, wherein the heating step takes place in an atmosphere comprising a gas selected from the group consisting of argon, nitrogen, and a combination thereof.

31. The method of fabricating a composite phase diamond material according to claim 11, wherein the heating step takes place under a pressure of about 1 atm.

32. The method of fabricating a composite phase diamond material according to claim 11, wherein the heating step comprises a holding time of from about 1 hour to about 300 hours, or from about 1 hour to about 80 hours, or from about 5 hours to about 80 hours.

33. The method of fabricating a composite phase diamond material according to claim 11, wherein the method comprises a treatment step comprising a treatment selected from the group consisting of focused ion beam treatment, 3D printing, plasma assisted polishing, and a combination thereof.

34. A method for temperature sensing, including cryogenic temperature sensing, comprising the steps of:
a) providing a sensor comprising a composite phase diamond material according to claim 1;
b) placing the sensor at a location where the temperature is to be measured; and
c) obtaining a signal corresponding to the temperature of the location from the sensor.

35. A method for temperature sensing, including cryogenic temperature sensing, comprising the steps of:
a) providing a composite phase diamond fabricated by the method according to claim 11;
b) placing the sensor at a location where the temperature is to be measured; and
c) obtaining a signal corresponding to the temperature of the location from the sensor.
